(19) United States
(12) Patent Application Publication
(10) Pub. No.: US 2006/0078859 A1
(43) Pub. Date: Apr. 13, 2006

(54) System and method for monitoring and responding to device conditions

(76) Inventor: Terence J. Mullin, Tustin, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 11/248,100

(22) Filed: Oct. 12, 2005

Related U.S. Application Data
(60) Provisional application No. 60/618,197, filed on Oct. 12, 2004.

(51) Int. Cl. G09B 19/00

(52) U.S. Cl. 434/219

(57) ABSTRACT

A system and method for monitoring and responding to device conditions is provided. A content server monitors sensed conditions of a device. Upon detection of an action-triggering condition, such as an error in the device, the content server accessed databases containing information pertaining to the monitored device in order to determine the nature of the error. When the error is identified, a database including a library of instructional content is accessed and the content server selects appropriate instructional content to enable a user to resolve the issue that prompted the error condition. Once the content server has chosen the correct instructional media, the content is delivered to a device client comprising a display screen at or adjacent the monitored device. Preferably, the instructional media comprises full motion video so that the device user simply copies what is seen on the display in order to resolve the issue. Action-triggering conditions can also include issues such as maintenance needs, training conditions, and user help requests.

### CROSS-REFERENCE TO RELATED APPLICATIONS

This application claims priority to U.S. Provisional Application No. 60/618,197, which was filed on Oct. 12, 2004, the entirety of which is hereby incorporated by reference.

### BACKGROUND OF THE INVENTION

1. Field of the Invention

The present invention is in the field of managing devices having condition sensors. More specifically, the present invention relates to monitoring such devices and delivering appropriate instruction in real time to device users as needed.

2. Description of the Related Art

Today's society is increasingly dependent upon highly technical labor-saving devices. Such devices include, for example, copy machines, computers, computer printers, scanners, telephones, film processors, laboratory analytical equipment, automobiles and the like. Such devices are making more and more use of high technology, and tend to become more and more complex as technology advances. Although these devices usually work quite well and provide important benefits, inevitably they will occasionally develop errors in operation and/or require certain maintenance, or a user may need guidance in use of the device. At such times, a knowledgeable person typically must take action to correct the error and to restore the device to proper operation, or provide additional training for a user. This can result in significant equipment downtime, inconvenience, and cost.

Most consumer devices are provided with an instruction manual to help users operate the device and possibly troubleshoot occasional errors. However, such instruction manuals are typically very difficult to read, and often are misplaced by users. When a problem occurs with a device, the user typically must spend exorbitant amounts of time just to locate the appropriate pages of the instruction manual, if the manual can be located, and then must invest substantial effort figuring out how to apply the instruction manual text to the actual problem. This leads to wasted time and frustration, as well as increased downtime for the device.

Some electromechanical devices, such as certain copy machines, include sensors that detect error conditions. Some of these machines also include routines to help users remedy sensed error conditions. For example, in the event of a paper jam, some copy machines will sense the general location of the paper jam, and will provide a series of instructions for a user to locate and correct the problem. However, experience has proven such instructions to often be incomplete and/or difficult to follow, and users may simply walk away from the machine rather than solve the problem because of the difficulty associated therewith.

Further, technology is advancing at astronomical rates, and the workforce cannot keep pace with the advances in technology in connection with all of the devices that users typically encounter. Thus, users that are not trained on the intricacies of the equipment are relying upon such equipment, and when called upon to fix even minor errors or address maintenance needs for such equipment, the users likely are incapable and/or unwilling to address such issues.

### SUMMARY OF THE INVENTION

Accordingly, there exists a need in the art for a system that monitors devices, detects errors, and delivers instructions to users of various technical levels in a form that is easy to follow and perform.

In accordance with one embodiment, a method for remotely monitoring and delivering context-sensitive instruction to a device is provided. The method comprises receiving an electronic signal indicating a device condition and accessing a database to determine whether a response need is warranted in response to the device condition. If a response need is warranted, the method provides accessing a database to provide instructional media concerning the device condition, and directing delivery of the instructional media to a user interface at or adjacent the device.

In further embodiments, response needs may include, for example, device error conditions, device maintenance needs, and user help requests. In still further embodiments, the instructional media is formatted according to user preferences, device location, and the like. In additional embodiments, notifications to certain personnel or network clients may be automatically generated upon satisfaction of certain conditions.

In accordance with another embodiment, a method is provided for remotely monitoring a plurality of devices and delivering context-appropriate media. The method includes electronically receiving a first error signal corresponding to an error condition detected in connection with a first one of the monitored devices, providing a database comprising a plurality of instructional media files comprising instructions for resolving a plurality of potential error conditions of the monitored devices, the database correlating a first instructional media file to the first error condition signal, accessing the database and identifying the first instructional media file as corresponding to the first error condition signal, and delivering the first instructional media file to a user interface at or adjacent the first monitored device.

In accordance with yet another embodiment, a system is provided for monitoring a device and delivering context-appropriate instructional information to a user interface at or adjacent the device. The system comprises a device having at least one sensor adapted to detect a condition of the device and to generate a sensor signal indicating the detected condition and a content server adapted to receive and analyze the sensor signal. The content server comprises a device database having technical information concerning sensor signals, a library of instructional material corresponding to particular sensor signals, and a criteria for determining whether a sensor signal indicates a need for instructional material. The content server is adapted to access the device database to determine the meaning of the sensor signal, whether instructional material is needed, and to identify appropriate instructional material based upon the sensor signal if needed. A user interface is at or adjacent the device, and the content server is configured to communicate the identified instructional material to the user interface.

Additional features and benefits are provided in additional embodiments, as are described in more detail below.

### BRIEF DESCRIPTION OF THE DRAWINGS

FIG. 1 is a schematic representation of a group of devices that are serviced by a content server in accordance with an embodiment of the present invention.

FIG. 2 is another schematic representation of a portion of the embodiment of FIG. 1.

FIG. 3 is a flow chart depicting an embodiment of the invention.

FIG. 4 is a screen view depicting instructions being delivered in accordance with an embodiment of the invention.

FIG. 5 is a schematic diagram depicting another embodiment of the invention.

FIG. 6 is a flow chart depicting another embodiment of the invention.

FIG. 7 is a schematic diagram illustrating an embodiment of the invention in which several different types of devices are monitored by a server.

FIGS. 8-19 are screen views showing administrative management aspects and methods in accordance with an embodiment of the invention.

FIG. 20 is a screen view depicting monitoring of a device in accordance with an embodiment of the invention.

FIG. 21 is a schematic view of a further embodiment of the invention.

FIG. 22 is a flow chart depicting another embodiment of the invention.

### DETAILED DESCRIPTION OF PREFERRED EMBODIMENTS

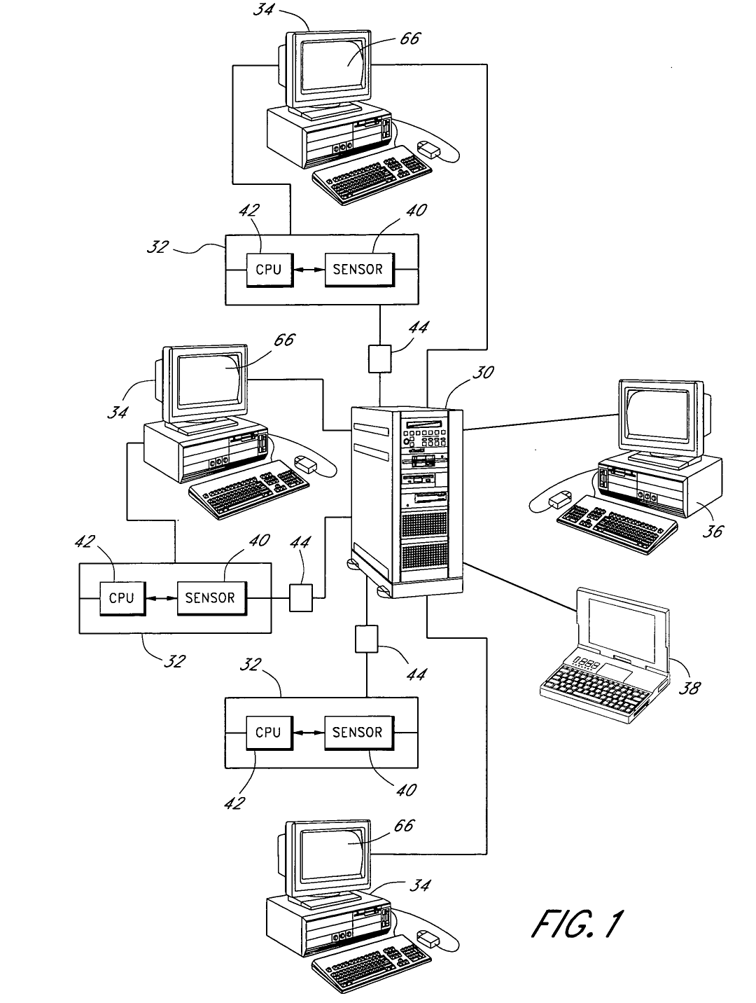

With reference first to FIG. 1, a relatively simple device network is illustrated. In the illustrated embodiment, a content server 30 is electronically connected to a plurality of electromechanical devices 32, a corresponding plurality of device clients 34, an administrative client 36 and a technician client 38.

In this specification, the term “electromechanical device” is a broad term that includes, without limitation, any device having some mechanical mechanism or interface, and which includes at least one sensor capable of electronically detecting and communicating certain device conditions. Examples of electromechanical devices include computer printers, copiers, laboratory analysis devices, and automated manufacturing machinery. It is to be understood that such devices need not be originally manufactured with the sensors, but sensor(s) may be added in order to detect and electronically monitor certain conditions.

Throughout this specification, the term “server” is a broad term that includes, without limitation, a computer or a computer system that is adapted to communicate and interact with a plurality of devices by way of a network or other communication connection. Further, although the singular term server may be used, it may actually refer to multiple servers that are interconnected so as to work together. In fact, a server may, for purposes of this specification, appropriately include several linked-together computing devices that are arranged in disparate locations throughout the world, but are functionally linked in operation.

In the illustrated embodiment, communication between devices is over a network, such as a local area network, wide area network, ethernet, or the like. It is to be understood, however, that in other embodiments any type of communication between such devices, including, for example, Internet, Intranet, wireless, and other types of electronic communication, can appropriately be used.

With continued reference to FIG. 1, in the illustrated embodiment, the electromechanical devices 32 are each substantially the same type or model of device. Each device 32 has one or more sensors 40 that are adapted to sense certain conditions, including error conditions, of the respective device. The illustrated electromechanical devices each include a computer processing unit 42 (CPU) that is adapted to, among other things, receive and analyze sensor signals.

An electronic interface 44 is disposed in the line of communication between the device 32 and the content server 30. The electronic interface 44 is customized for the model of electromechanical device, and is configured to receive sensor signals from the device 32 and translate them into a signal format that will be recognized by the content server 30. The electronic interface 44 is especially helpful in devices that are typically not network aware, such as, for example, a device that does have its own CPU or another medium for communicating electronically with the content server 30 in order to communicate sensor signals to the content server 30. In embodiments wherein the device 32 includes a CPU, the operation of the electronic interface may alternatively be programmed into the CPU so that the CPU performs the role of the electronic interface, and a separate electronic interface is not necessary.

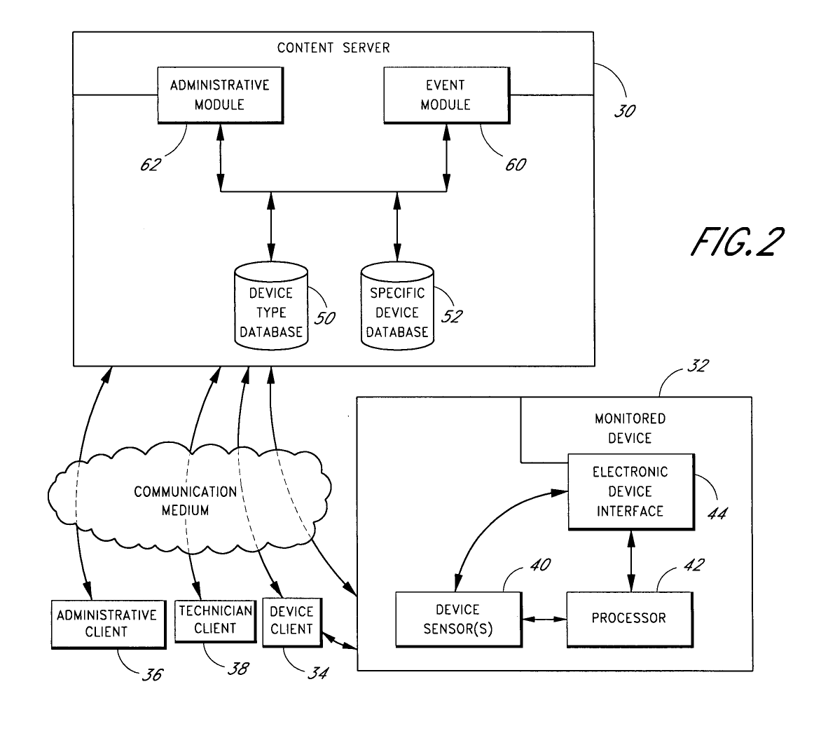

With reference also to FIG. 2, which is another schematic representation depicting the content server 30 and one of the devices 32 of the embodiment in FIG. 1, the content server 30 has access to a device-type database 50, which includes information on the particular model of electromechanical device and, preferably, a specific database 52 for each monitored device 34. The database 50 includes information on the meaning of certain sensor readings. More specifically, based upon the sensor signals received by the content server 30, an event module 60 of the content server accesses the device database 50 to determine what the sensed device condition is, whether there is an error condition, what the particular error is, and what procedure is necessary to resolve the error. An administrative module 62 of the content server 30 records data in connection with the sensed condition in a log kept in the database 52 for the specific device from which the condition is sensed. As such, the content server 30 simultaneously determines the existence of an error condition and records data such as time, location, device, and the like to the database for the specific device.

Preferably, the device type database 50 includes instructional content to guide a user or technician through resolving sensed problems or performing certain operations. Instructional content in this database can take various forms. For example, a library of textual instructions, diagrams, photographs, animations, or combinations of such may be employed. Preferably, the library includes several short video/multimedia clips that are tailored to specific situations and/or error conditions. Preferably, such instructional media is adapted to walk a user step-by-step through fixing or otherwise addressing a sensed error condition or maintenance need in order to resolve the condition quickly and easily. Such media can also be used, upon a user's request, to guide a user through an operation. Further, if sensed conditions indicate that a user is improperly performing an operation, such instructional media may selectively be provided to get the user back on track.

With continued reference to FIGS. 1 and 2, a device client 34 is arranged at or adjacent each electromechanical device 32. The device client 34 preferably includes a graphical user interface 66 that is able to receive instructional content from the content server 30 and display the content to a user at the device 32. Preferably, the device client 34 enables the user to regulate the speed at which instructional content is presented, including pausing, rewinding, etc. In the illustrated embodiment, the device client 34 includes a CPU and a user interface that enables a user to regulate and interact with the instructional content which, in a most preferred embodiment, includes full motion video and sound to show and tell a user exactly what to do to resolve a device condition.

In the illustrated embodiment, the device client 34 is depicted as directly electronically connected to the electromechanical device 32. It is to be understood that, in some embodiments, such a connection is not necessary so long as the device client 34 and device 32 both communicate with the content server 30. In further embodiments, the device client may comprise little more than a display screen for presenting information, and may allow minimal user interface with instructional content provided by the content server, a remote mainframe, or the like. In further embodiments, the device client may comprise a mobile computing device carried by the user.

In other embodiments, wherein the device client 34 is electronically linked to the device 32, the client 34 may perform multiple roles. For example, the electromechanical device may lack a CPU, and the device client may include a CPU that monitors the sensors 40 of the electromechanical device in lieu of a separate electronic interface. In still further embodiments, the device client can be physically incorporated into the electromechanical device. Further, the device client can comprise several different types of computing devices, including a PDA-type device, notebook computer, tablet PC, or the like. Additionally, although the device client 34 preferably includes a graphical user interface, it is to be understood that, in other embodiments, interfaces such as audio only, text only, audio/text, and the like may be acceptable.

In yet another embodiment, the device client 34 provides other benefits and services to the electromechanical device 32 not directly related to instructional content delivery. For example, it can serve as a user interface, enabling a user to log on to the electromechanical device. In still other embodiments, the device client can monitor certain performance data concerning the particular electromechanical device. For example, if the electromechanical device is a copy machine, the device client may monitor how many copies are made for particular case matters, and may store that information and/or communicate it to the content server (or another server) in real time or in accordance with a rule-based schedule such as hourly, daily, upon job completion, etc. In some embodiments, the CPU and/or device client may monitor sensed conditions, and only communicate such conditions to the content server 30 upon certain triggering events, such as a sensed error, user information request, or in connection with a pre-established rule.

With continued reference to FIGS. 1 and 2, the administrative client 36 and the technician client 38 are also connected to the content server 30. The administrative client 36 interacts with the content server 30, especially the administrative module 62 of the server 30, so as to set up and control the content server 30. Additionally, the content server 30 may generate reports and the like and send them to the administrative client 36. In accordance with one embodiment, the technician client 38 is a mobile device such as a laptop computer, PDA, pager, or the like. The content server 30 may interact with the technician client 38 in accordance with certain embodiments discussed in more detail below.

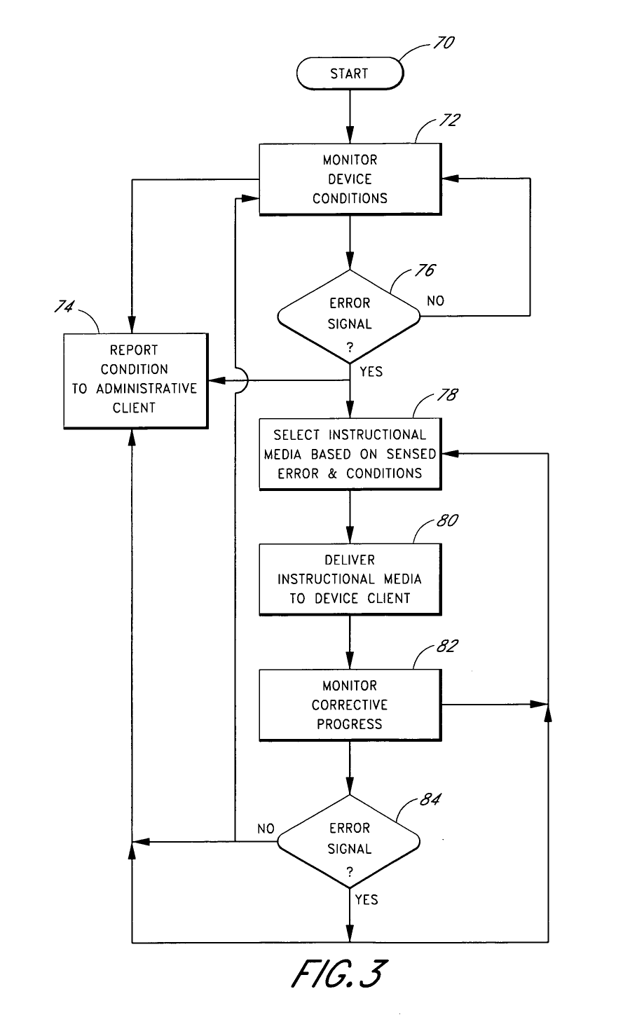

With additional reference to FIG. 3, a logical flow chart is presented describing certain operations of the embodiment described in FIGS. 1 and 2. The flow chart of FIG. 3 discusses aspects of the embodiment in connection with a sensed error condition. However, as will be discussed further below, principles discussed in connection with this and other embodiments can be applied to other sensed conditions, such as the sensed need for maintenance, a specific request from a user for instruction in connection with a particular operation, and/or a condition sensor analysis indicating that a user is performing an operation incorrectly, and would benefit from instructional media.

With reference to FIG. 3, the illustrated process begins when the system is started in accordance with the start button 70. In accordance with block 72, the content server 30 monitors conditions of all of the devices 34 that are connected to the content server by reviewing the sensor 40 signals that indicate the condition of certain aspects of the devices. In accordance with some embodiments, the content server 30 may report such device conditions, even if there is no error condition to the administrative client 36 as indicated in block 74. Preferably, the content server 30 reports certain conditions to the administrative client 36 based upon rules established by the administrative client 36. For example, the content server 30 may make an hourly update of the current condition of each monitored electromechanical device 34, or may automatically generate other reports as desired. In other embodiments, the content server 30 reports conditions to the administrative client 36 only upon occurrence of certain triggering events, such as sensed error conditions, changes in device status, and the like.

With particular reference next to decision block 76, an important part of monitoring the devices 32 is deciphering when an error is sensed in a specific device 32. If no error is detected, the system continues monitoring the devices 34. However, if an error is detected, the error is preferably immediately reported to the administrative client 36. In accordance with block 78, the content server 30 selects an appropriate instructional media based on the sensed error and, possibly, other sensed conditions of the device. In accordance with this step, the event module 60 of the content server 30 employs the sensor data it has received and accesses the device-type database 50 to match the received sensor data with error codes stored in the database 50 to determine exactly what error or errors are present. Once the error is identified, the event module 60 identifies suitable instructional media to assist a user in correcting the error in order to restore the device to proper operation. The criteria for selecting appropriate instructions is based mainly upon the sensed error, but can also consider other sensed conditions of the device, if relevant. Additionally, the event module 60 can consider aspects of the specific device, such as the localized language associated with the device's location. Thus, the content server 30 will deliver instructional media with appropriate written and audio language aspects.

Once the appropriate instructional media has been selected in accordance with block 78, the media is delivered to the device client 34 in accordance with block 80. As discussed above, the device client 34 includes an interface 66 for presenting instructional media to the user in order to walk the user step-by-step through resolving the issue.

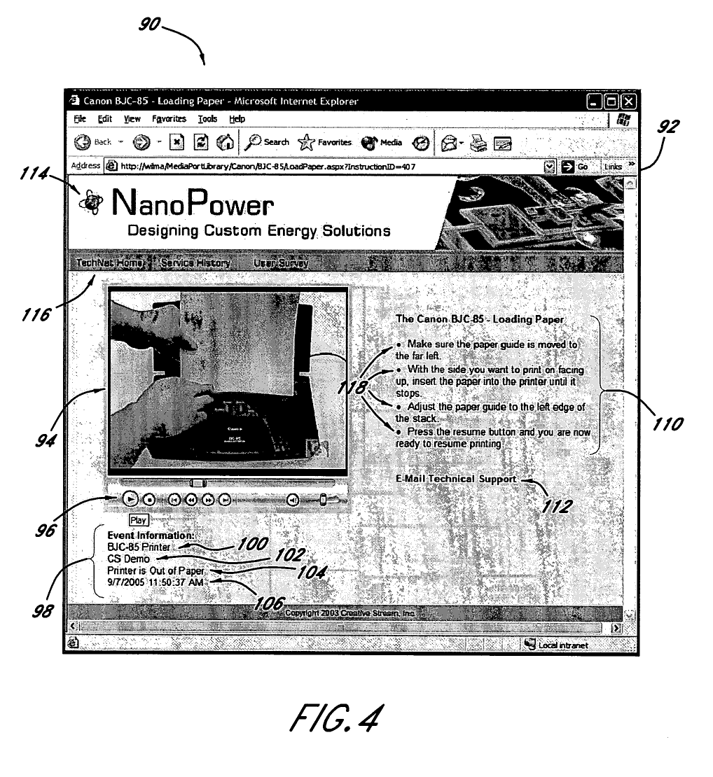

With reference also to FIG. 4, a sample screen view 90 of instructional media delivered in accordance with block 80 is presented. In the illustrated embodiment, the content server 30 and the device client 34 deliver instructional content and information in a web page-type format. As such, the screen view 90 basically shows a web page 92 that includes content and format established in accordance with known software, such as Microsoft Internet Explorer. In the illustrated embodiment, the web page 92 includes a media window 94 in which full motion video is presented, with or without subtitles. A series of controls 96 adjacent the media window 94 enables the user to customize presentation of the media. For example, the user can selectively play, stop, pause, fast-forward or rewind a full motion video presented in the media window 94. Preferably, audio is included with the video. Volume of the audio can also be controlled in accordance with the control bar 96. It is anticipated that, in certain embodiments, the device client 34 includes a mouse or other manner of interacting with the web page 92. In an additional preferred embodiment, the device client 34 display 66 comprises a touch-screen format so that the user can interact with the web page 92 by directly touching the screen 66.

With continued reference to FIG. 4, the instructional web page 92 preferably displays event information 98 concerning the sensed error condition. In the illustrated embodiment, the event information 98 includes relevant details such as the device type and model 100, the particular device, which can be indicated by device location 102, a short description of the sensed error 104, and the time 106 of the error condition.

As can be seen, the illustrated embodiment is a relatively simple example in which a computer printer has run out of paper. As such, the event information 98 identifies the particular model 100 of printer and a particular location 102 or name of the affected printer. As illustrated, the media window 94 presents full motion video showing an example of how to load the paper in a printer of the relevant model type. As such, the user can be walked step-by-step through the process of loading the printer with paper, and the user can resolve the error by simply copying the actions that are performed in the video shown in the media window 94. For example purposes, the illustrated embodiment is very simple. However, Applicant anticipates that more complex problem resolutions, including resolutions involving several steps, may be advantageously accomplished by providing instructions as described herein.

With continued reference to FIG. 4, although the media window 94 provides a primary conduit for delivery of instructional content, preferably step-by-step written instructions 110 are also included in the web page 92. Further, in the illustrated embodiment, if there are additional problems or if the user desires additional help, an HTML link 112 to request additional technical support is provided. It is to be understood that, in further embodiments, other HTML links can also be included, such as a link that directly pages or calls a technician. For example, clicking on a link to call a technician may prompt a call through the device client so that the user communicates with a technician directly through the device client. In still other embodiments, the technician correspondingly can access the same web page 92 displayed on the device client 34 in order to further assist the user in resolving the issue.

Continuing with reference to FIG. 4, other features may be included in the instructional delivery web page 92. For example, a graphics portion 114 may customize the, page to include graphics for a particular company, division, group, or the like. Additionally, tabs 116 may be included to enable a user to access a technical support home page, learn more information about the history of the particular device, and/or provide input to be used in further developing technology management systems.

In the illustrated embodiment, written text is depicted in English. However, depending on the location, and anticipated user profile of the device, different languages may be indicated. As such, in another embodiment, the content server 30 considers data concerning the local country/language as recorded in the device type database 52, and customizes the content and format of the web page 92 accordingly. Further, in other embodiments, instruction in multiple languages can be provided.

With specific reference again to FIG. 3, once instructional media has been delivered in accordance with block 80, the content server 30 continues to monitor the progress of the device in accordance with block 82. In certain embodiments, this may be accomplished by monitoring sensed conditions including both the sensed error and other sensed conditions in the device. For example, for some errors and devices, it may be necessary to remove a device panel to access a particular component that requires service. A sensor will detect when such panel is removed, and will accordingly signal the content server 30. While monitoring progress in accordance with block 82, the content server 30 will thus be aware when a user has removed the panel, and thus is able to monitor progress toward resolution of the issue.

With additional reference again to FIG. 4, the step-by-step written instructions 110 may be configured to follow the progress of the user in resolving the issue. For example, in accordance with one embodiment, the next step 118 of the instructions 110 to be performed by the user is highlighted. Once the step 118 is completed, as monitored and verified by sensors of the device, the content server 30 becomes aware that the step 118 has been completed; the web page 92 is updated to graphically alter the completed step, and the next step is highlighted.

In still another embodiment, the written step-by-step instructions 110 may be linked to the full motion video delivered in the media window 94. For example, if the user is uncomfortable with certain steps, the user can make a mouse click directly on a particular step 118, and the media will be adjusted to that portion of the media corresponding specifically to that step. Moreover, although this discussion is in the context of full motion video, it is to be understood that other instructional media, such as animations, diagrams, still photographs, and the like can also be used and incorporate the principles discussed herein.

With specific reference again to FIG. 3, as the content server 30 monitors corrective progress in accordance with block 82, the content server 30 will continue to select appropriate instructional media based on the sensed conditions in accordance with block 78. For example, if the user, while attempting to correct the problem, causes additional problems or begins taking incorrect steps, and sensors indicate such, the content server 30 may, depending on pre-established rules, deliver new and/or different instructional media to the device client; in one embodiment, an alarm will warn the user to stop taking incorrect steps. The alarm may be in audio format, video format, or both.

With continued reference to FIG. 3, in accordance with block 84, the content server 30 will continue to monitor whether the error signal persists. As long as the error signal persists, this condition preferably continues to be reported to the administrative client 36 in accordance with block 74. Additionally, the content server 30 will continue to monitor whether additional or alternative instructional media is warranted. When the user has corrected the problem and there is no longer an error signal, termination of the error signal preferably is reported to the administrative client 36, and the system returns to basic monitoring of device conditions in accordance with block 72.

In accordance with the illustrated embodiment, several references have been made to reporting conditions to the administrative client in accordance with block 74. It is to be understood that many different approaches can be taken to reporting conditions. In accordance with one embodiment, upon sensing an error condition, an email is automatically generated to the administrative client 36. Additionally, in certain embodiments all reports to the administrative client are by automatically-generated email. Condition updates can be generated according to email schedules. For example, after a specified period of time defined by a rule, an email may be generated to update the administrative client concerning the condition of the error resolution. In another embodiment, the administrative client may include a device monitoring screen. The device monitoring screen may be continuously updated to indicate device status. As the device monitoring screen may be monitoring several different devices, reports that may be triggered by certain triggering events, such as sensed error conditions as depicted in blocks 76 and 84 of FIG. 3, may be depicted in a highlighted textual format so as to stand out as abnormal conditions. In a still further embodiment, condition reporting can include a plurality of forms. For example, an email may be generated automatically upon detection of an error signal in accordance with block 76. Thereafter, the administrative client is periodically updated us to the status of the monitored device via a message box instead of an email. Similarly, upon resolution of the error in accordance with block 84, an email or other message may be generated to the administrative client.

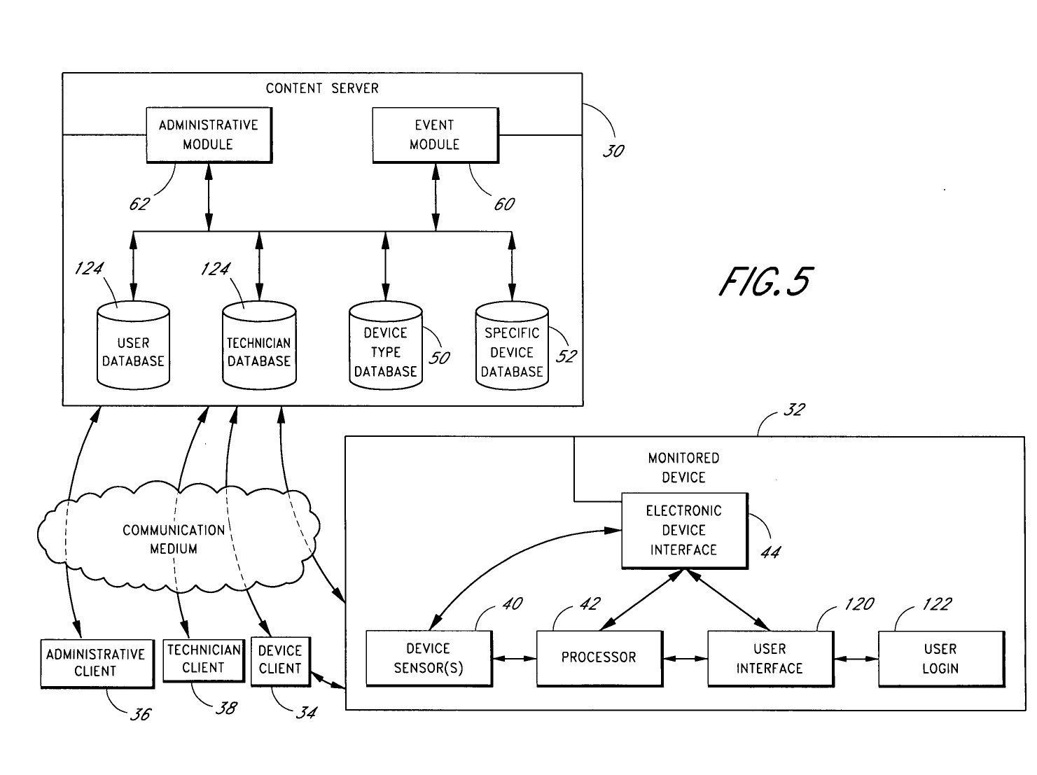

With reference next to FIG. 5, a more detailed schematic representation of the content server 30 and one of the monitored devices 32 as shown in FIG. 1 is depicted. As with the embodiment discussed above in connection with FIG. 2, the content server 30 includes an event module 60, administrative module 62, and databases such as a device type database 50 and a specific device database 52. Similarly, the monitored device 32 includes sensors 40, CPU 42, and a device interface 44. As discussed above, various embodiments may combine certain of the electromechanical device components.

The embodiment represented in FIG. 5 additionally comprises further features and aspects. For example, the device 32 preferably includes a user interface 120 such as a computer screen or the like, and enables a user to log in 122 to the device 32 and thus be recognized by the network and content server 30. In certain embodiments, a device client 34 may incorporate certain aspects of the device 32, including the user interface 120.

With continued reference to FIG. 5, the content server 30 preferably additionally comprises a user database 124, which maintains data on specific device users. The user database 124 includes information that may be relevant to the event module 60 in selecting an appropriate technical level of instructional media to provide to a particular user, and the format of such media. For example, a user database 124 includes data related to the technical expertise of the user, including training with particular devices, educational background, and the like. The user database 124 further includes user preferences such as preferred language for audio instructions, written instructions, and/or subtitles (to full motion video), preferred web page layouts, text sizes, image sizes, special needs, and the like. Preferably, the user can specifically design their desired preferences. For example, one user may specifically request subtitles to full motion video, and for the subtitles to be in a first language, but for the audio to be in a second language, and written instructions to be in a third language. More precisely, each individual user preference preferably is independently adjustable by and/or for the user.

Further, the user database 124 preferably includes historical data relating to the user's history in addressing certain problems with certain equipment. For example, the database includes records of when error events have occurred when the user was logged on to certain equipment, what the error was, whether the user was able to resolve the error without further technical support, and how much down-time resulted from the error. As such, not only may device performance be monitored, but user performance, both good and bad, in relation to devices can also be monitored. Additional user information may be stored in the user database 124 as appropriate.

The content server 30 preferably also has access to a technician database 126, which stores information on service technicians or others that may be qualified or willing to help address certain equipment problems. The technician database 126 preferably includes data such as each technician's technical expertise, special training, and the like including preferences and other information such as that tracked by the user database. Further, the technician database preferably maintains experience records, such as a log of errors that have been addressed and resolved by the technician, as well as errors that have been addressed but were not able to be resolved by the technician, and which required further support. In an additional embodiment, the technician database 126 monitors the schedule and/or location of technicians. As such, when a technical need arises, not only can the content server 30 select an appropriate technician to solve the equipment problem, but the content server 30 may schedule the technician's time, notify the technician of the appointment and generate a work order to track the service call. It is to be understood that technicians can also take action, preferably through a technician client that the technician carries with them, to update the content server 30 as to their status. The administrative module 62 of the content server 30 will then update the technician database 126 accordingly.

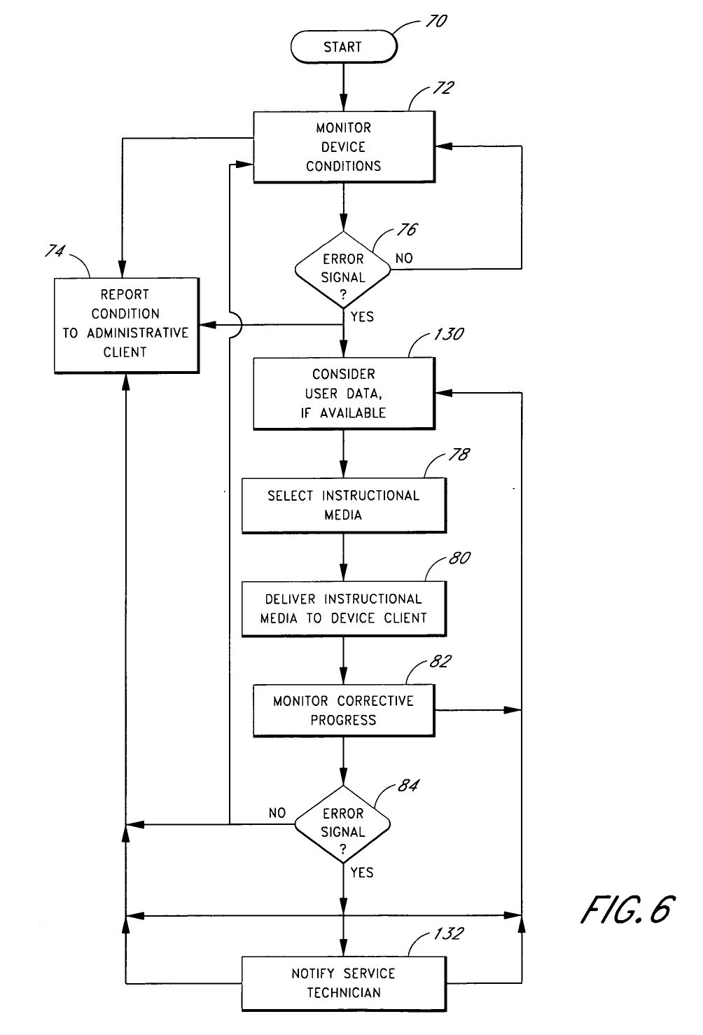

With reference next to FIG. 6, a logical flow chart is presented describing certain operations in connection with the embodiment described in connection with FIGS. 1 and 5. The process is generally similar to the flow chart presented and discussed in connection with FIG. 3, and thus similar reference numbers have been used for similar operating blocks.

With reference to block 130 of FIG. 6, when an error signal is detected in accordance with block 76, the content server 30 determines whether a user has logged in. If a user has logged in to the device 32, then user data from the user database 124 may be relevant when selecting instructional media. As discussed above, the instructional media preferably is chosen by the event module 60 of the content server 30 based mainly upon the diagnosed error, but also considering user data. For example, a full motion instructional video delivered to the media window 94 will be accompanied by audio in the preferred language spoken by the user. Still further, for users having a very low technical expertise, a more detailed instructional media content may be delivered than for a user that has high technical expertise and/or training.

With continued reference to FIG. 6, delivery of instructional media and monitoring of the corrective progress preferably proceeds in a manner similar to the embodiments discussed above. However, if after a user has attempted to remedy the problem, the error condition continues, a service technician is notified in accordance with block 132. It is to be understood that, in additional embodiments, pursuant to predetermined rules, notification of a service technician may not take place until after a certain time period has lapsed, or a certain number of attempts have been made by the user to fix the problem. Additionally, in some embodiments, for certain sensed errors that are especially difficult or require advanced expertise to resolve, the content server 30 can completely bypass any attempt of having a user solve the problem, and will notify a technician immediately.

As discussed above, the content server 30 can not only select a technician, but can, in some embodiments, schedule their time for resolving the relevant device issue. At this juncture, the content server 30 may, if desired, display a notice on the device client 34 indicating that the device 32 is out of order and that a technician will be addressing the issue. Further, the device client 34 may display the name of the assigned technician and the time at which the technician is scheduled to address the issue. Further, in one embodiment, once a technician is assigned and scheduled, a report may be made to the administrative client 36 and/or to the manager in charge of the device to that effect.

When the technician arrives at the device 34, the technician informs the content server 30 of his arrival, such as by logging onto the device 32, communicating through a technician client 38, or otherwise. At such time, the content server 30 will consider the technician to be the user, and select suitable instructional media as appropriate in accordance with block 78.

With reference again to FIG. 5, the technician preferably carries a technician client 38, which may comprise a mobile computing unit such as a laptop computer, PDA, or the like. Preferably, the technician client 38 is configured to receive instruction from the content server 30 and to allow the technician to interface with the content server 30 to provide updates, instruction, or the like. Further, in another embodiment, the technician may access the content server 30 via the device client 34 associated with the device 32. Preferably, the technician may log in to the server 30 via the device client 34 so that suitable media is delivered.

In the embodiments discussed above, the content server 30 may direct instructional media to be delivered to the device client 34 and/or technician client 38. Thus, such media may be delivered simultaneously to multiple locations. In certain embodiments, such as very large machinery, or in accordance with certain management preferences, instructional media may be simultaneously delivered to one or more device clients at or proximate the monitored device 32, and also to one or more clients remote from the device, such as an equipment manager client. Further, instructional media delivery formats, such as size of a media window or the like, may be customized based on device parameters, such as size, location (i.e., on a loud manufacturing floor), or the like.

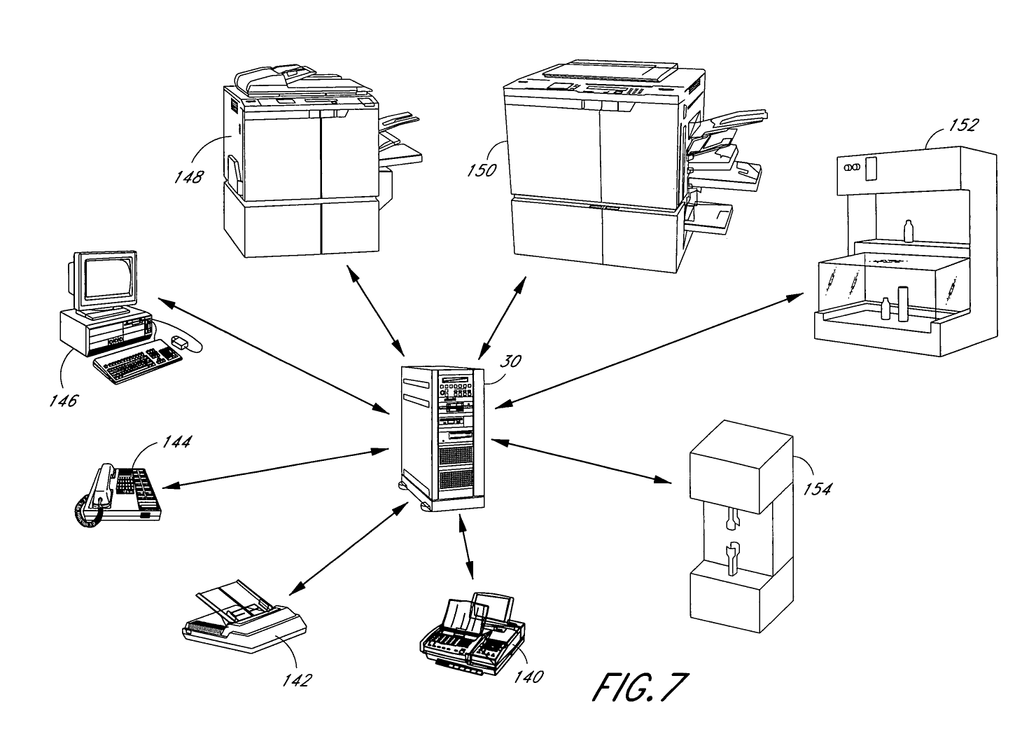

For purposes of simplicity in presentation, the embodiments illustrated and discussed above in connection with FIGS. 1-6, involve a network having a plurality of devices 32, but wherein each of the devices are of the same or similar model. With reference next to FIG. 7, another embodiment is schematically illustrated in which a network includes several different types of devices. In FIG. 7, each schematically illustrated device is intended to represent a family of similar devices that are connected to a common content server 30. It is to be understood that the content server 30 illustrated schematically may comprise a plurality of linked servers or another type of computer system in accordance with the broad definition of server used throughout the specification.

With continued reference to FIG. 7, in such a large scale embodiment, the content server 30 monitors and interacts with several different types of equipment. For example, the content server 30 regulates several different groups of different types of office equipment, which are represented schematically as a group of fax machines 140, a group of computer scanners 142, a phone system 144 or group of phone systems, a computer, computer network or group of computer networks 146, a group of a first type (make and model), of copy machine 148, and a group of a second type (make and model) of copy machine 150. Additionally, it is contemplated that the content server 30 can monitor more technically complex equipment such as laboratory analytical equipment 152, mechanical testing equipment 154 such as an Instron™ strength testing machine, as well as large scale manufacturing equipment such as commercial looms, CNC machinery, robotic welders, and so on. Indeed, it is contemplated that the principles associated with the invention can be applied to any machine, and group of machines, that can be electronically monitored using sensors or the like.

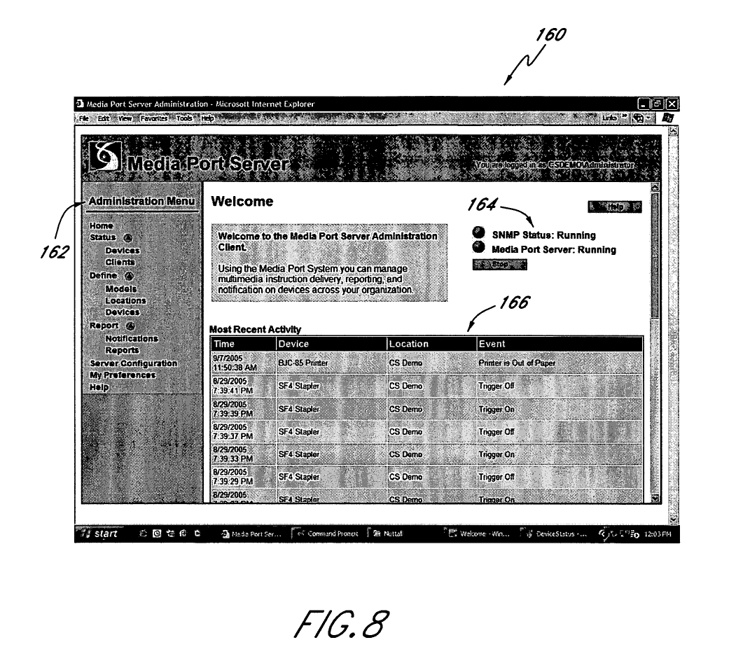

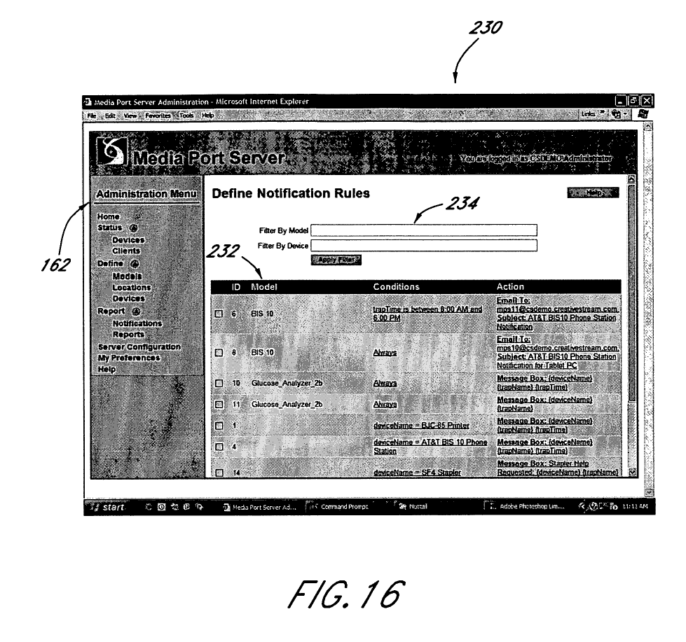

FIGS. 8-19 are a series of screen views taken from an administrative client 36 that accesses the administrative module 62 on the content server 30. The screen views show various administrative aspects of an embodiment.

With reference first to FIG. 8, a welcome screen 160 of the administrative client is illustrated. The welcome screen reflects access to the content server 30, which is referred to as the “media port” server in the illustrated embodiment. Throughout the administrative client 36, the screen views typically are provided in a web page format, and typically include an administration menu 162 that provides access to certain features of the administrative client. The welcome page 160 of FIG. 8 includes certain general information, such as the status 164 of the computer systems, including the content server 30, and a table 166 indicating recent activity in the monitored devices. As shown in the illustrated table 166, in certain embodiments, multiple different types of devices can simultaneously be monitored and administered by the content server 30 and administrative client 36.

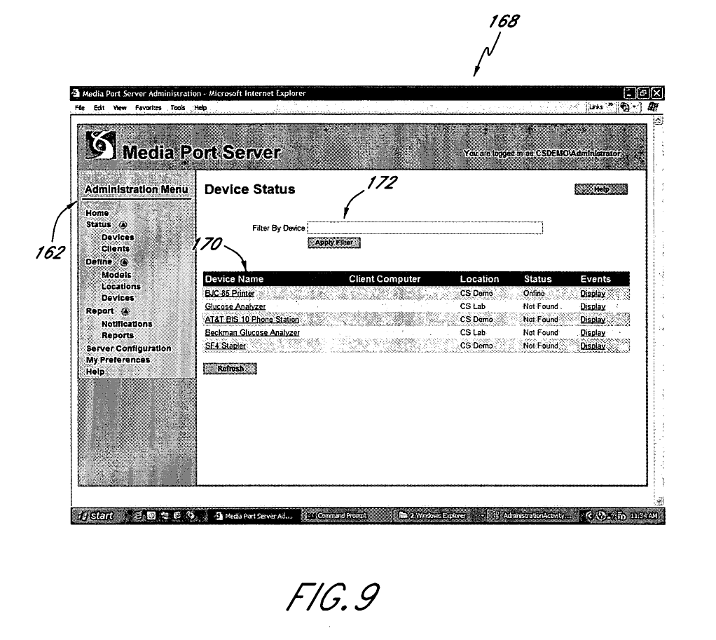

With reference next to FIG. 9, a device status page 168 includes a status table 170 that displays the current status of each device monitored by the administrative client 36. As illustrated, different types of devices and different locations are included in the table 170. Although only five different devices are monitored in the illustrated embodiment, it can be appreciated that several hundred or even thousands of devices can be monitored in other embodiments. As such, the device status page 168 preferably includes a filtering option 172, which enables the administrator to sort the devices as desired in order to group devices with common characteristics, such as the same model of device, same location, status, or the like.

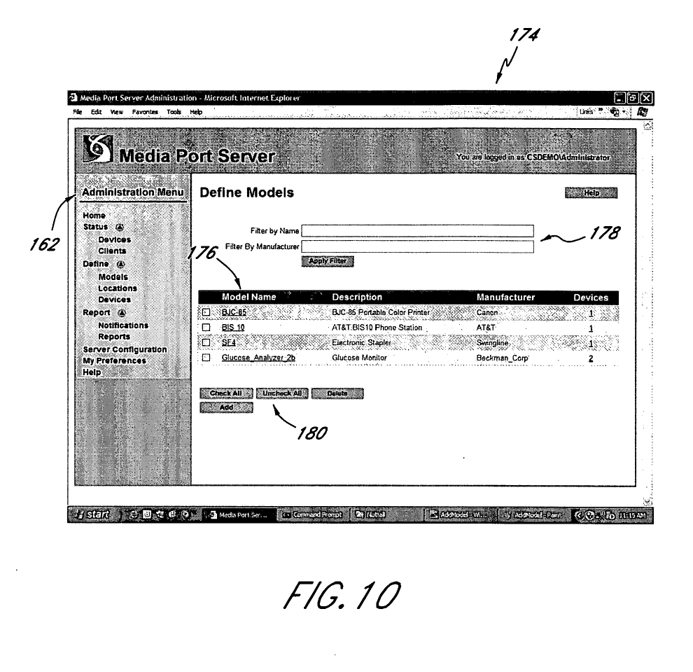

With reference next to FIG. 10, a define models page 174 of the administrative client is illustrated. The define models page 174 presents a table 176 listing every different model of device monitored by the system, including certain descriptive information about each model and the list of the number of devices of each model that are monitored. In the illustrated embodiment, the table 174 lists four different models, which are four unrelated types of devices. For each listed model, a brief description and listing of the manufacturer of that particular model are presented. Further, the number of devices monitored by the content server 30 are presented. Again, in more complex and larger embodiments, it may be advantageous to sort models by common characteristics. Thus, a filtering block 170 enables a user to filter by name and/or manufacturer.

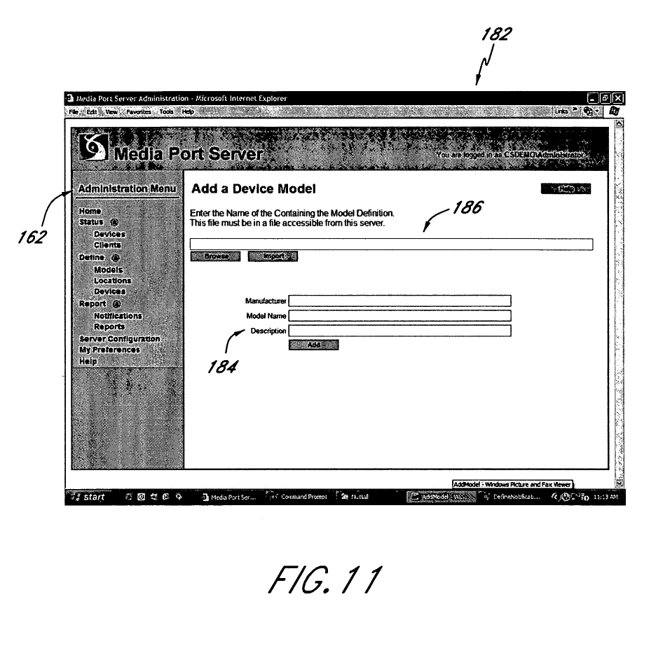

With continued reference to FIG. 10, the define models page 174 includes administrative tabs 180 that enable the administrator to interact with and perhaps modify information concerning certain models. Specifically, for instance, one of the administrative tabs 180 enables a user to add a new model. In fact, with reference also to FIG. 11, an add model page 182 is accessed when the “add” administrative button 180 of FIG. 10 is actuated. This page 182 enables an administrator to add a new model, or type, of device for the content server 34 to monitor. Blocks 184 are provided for entry of certain descriptive information about the model. Further, a model definition block 186 is provided. In the illustrated embodiment, the model definition block 186 comprises a link or address to a file that defines aspects of the model. For example, sensor codes and their corresponding meanings are included in the model definition. Basically, the model definition enables the content server 30 to appropriately communicate with devices in this family of model.

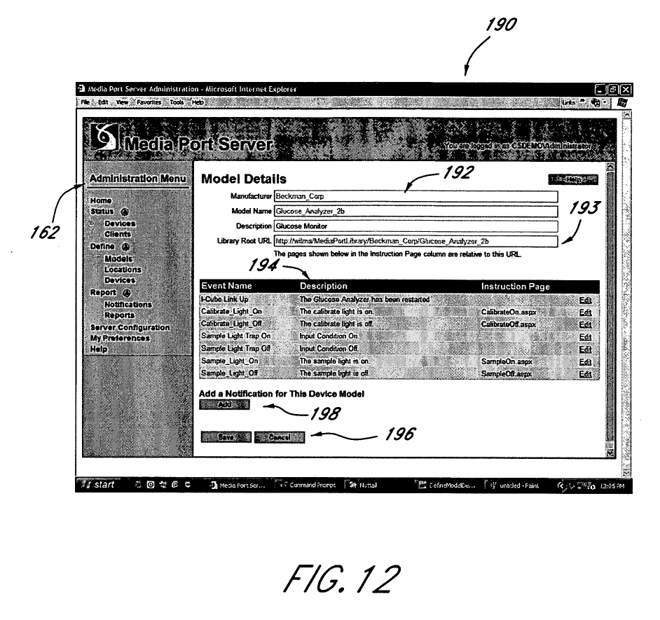

With reference again to FIG. 10, in the table of models 176 discussed above, the model name preferably includes an HTML link to details about that particular model. With reference also to FIG. 12, a model detail page 190 is provided. In the illustrated embodiment, the model detail page 190 is linked so as to be accessed when the corresponding model name HTML link, in this embodiment, “Glucose_Analyzer_{—}2b” is actuated. The model detail page 190 includes description blocks 192 with basic information about the models, as well as a pathway indicator 193 to more detailed information, specifically, device-type information that will be found in the device-type database 50.

An event table 194 of the page describes various sensed conditions and events associated with this particular model of device. Within the event table 194, each event name refers to a sensed condition. A description is provided which corresponds to each sensed condition. Not every sensed condition indicates an error condition that requires an instruction. However, some sensed conditions are indicators of a need for maintenance and/or of an error condition, and the event table 194 includes references to instructional media that corresponds to certain triggering events. For example, in the illustrated embodiment, when the sensed event “Calibrate_Light_On” is detected, the appropriate instructional media content to be delivered to the associated device client is the “CalibrateOn.aspx” file, which is accessible via the device path 193, and which is stored in the device-type database 50.

With continued reference to FIG. 12, the illustrated embodiment is a fairly simple embodiment wherein an event is tied directly to specific instructional content. Thus, in the illustrated embodiment, when the sensed event occurs, the content server uses that occurrence as the sole criteria for selecting appropriate corresponding instructional media to be delivered to the device client 34. However, as discussed above, in certain embodiments, the content server 30 considers multiple factors in selecting appropriate instructional media. Thus, in additional embodiments, the event table 194 will include references to rule groups corresponding to certain events. A rule group is a set of instructions that instruct the content server which factors to consider from the device-type database 50, specific device database 52, user database 124 and/or technician database 126, and precisely how to weight such factors in selecting appropriate instructional media. Additionally, in further embodiments, instructional media and associated rule groups may depend upon multiple event condition data. Specifically, the instructional media or other action taken by the content server may rely on one, two, or several sensed conditions, rather than a single sensed error condition.

The model detail page 190 enables a user to edit certain features of the models. As such, it includes “save” or “cancel” tabs 196 to enable the administrator to save or cancel any modifications. Additionally, there is a tab 198 for adding notifications in relation to certain events or the like. Such notifications will be discussed in more detail below.

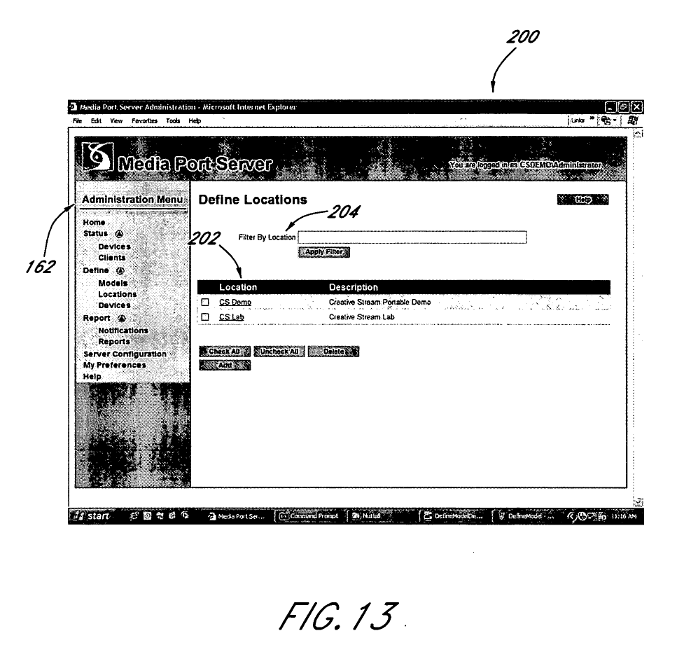

With next reference to FIG. 13, a define locations page 200 comprises a location table 202 that presents information on locations monitored by the content server 30. In the illustrated embodiment, only two locations are defined. However, in other applications, for example, for large multinational corporate applications, there may be many different locations disposed in various parts of the world and/or in various parts of a building. As such, an administrator can define the locations pursuant to any criteria that is most convenient, including country, city, building, room, or the like. Again, since several locations may be used, a filtering block 204 is provided to help the administrator sort the locations.

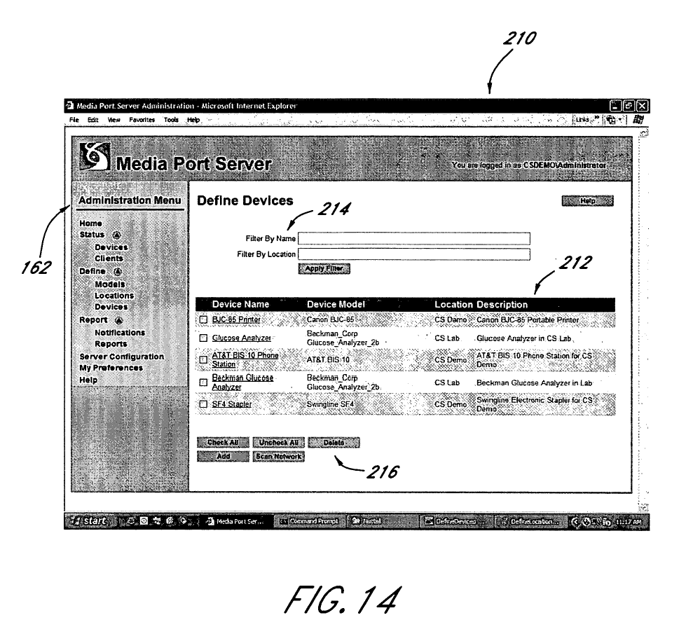

With reference next to FIG. 14, a define devices page 210 includes a device table 212 that lists all devices monitored by the content server. This page varies from the define model page 174 of FIG. 10 in that every single monitored device may be listed, rather than groups or models of devices. Again, since the number of devices can be difficult to manage in certain embodiments, filtering blocks 215 are provided. Similarly, administrative tabs 216 enable the administrator to access, add, and otherwise administer to the listed devices.

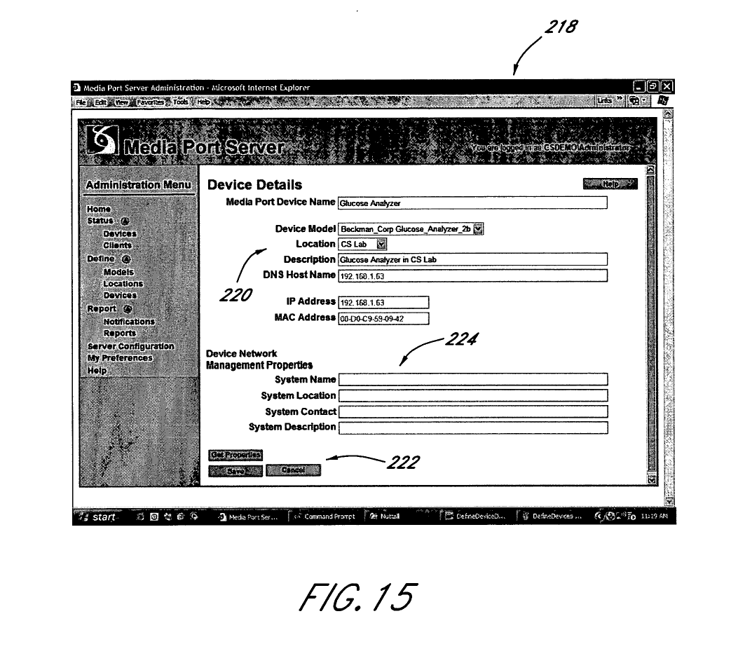

With reference also to FIG. 15, a device detail page 218 is presented. This page preferably can be accessed from the define device page 210 discussed in connection with FIG. 14. The device table 212 of the define device page 210 includes a list of devices by name and, in the illustrated embodiment, the device names comprise HTML links to the associated device detail page 218. The detail page 218 includes certain device information 220, such as model, location, description, etc. Additionally, the device's IP address and other addresses for enabling network communication with the specific device are presented. Administrative tabs 222 enable the administrator to obtain and define even more information about each device, and additional input blocks, such as those of 224, provide space for recordation of further information on each device. The illustrated input blocks 224 are concerned with network management; however, it is to be understood that several types of information can be added as desired by the administrator.

With continued reference to FIGS. 14 and 15, and additional reference to FIG. 11, adding a device to be monitored by the content server 30 includes both adding the device model in accordance with FIG. 11, and adding each specific device in accordance with FIGS. 14 and 15. For example, in the illustrated embodiment, adding the device model in accordance with FIG. 11, includes entering certain information about the type of device and including the model definition 186, which points the content server 30 to specific information about the device, sensor setup, and the like.

Once the device model has been added and defined, several individual devices of that particular model may also be added in accordance with FIGS. 14 and 15. In the illustrated embodiment, the device details as set out in blocks 220 assign a specific location, IP address or the like to the specific device, but point to information concerning the model for model definitions, including sensor meanings, links to instructional materials, and the like. In further embodiments additional information regarding each individual device can be entered in order to reflect customization of the particular device in a manner that may be different from other devices of the same model that are also monitored by the network. For example, in some embodiments, certain aftermarket customization, such as additions by the particular user group, may result in additional features and capabilities. Correspondingly, these modifications may warrant additional sensor inputs and even additional instructional material that may be unique to the specific device. In such embodiments, the device details page 218 can be customized to include links and alerts to such customizations for the content server 30 to consider when determining the meaning of sensed conditions and delivering context-appropriate instruction.

Further, specific device aspects may warrant specific formatting for a corresponding instructional delivery web page 92. For example, in an embodiment in which a device is adapted to be simultaneously used by multiple users, possibly of differing language capabilities, this fact can be recorded in a manner to trigger a instructional delivery web page 92 customization in which subtitles to full-motion video are simultaneously provided in two or more languages.

In the illustrated embodiment, adding devices has been divided up into groups of devices of a particular model, and specific devices within that model. However, it is to be understood that any type of organization of device types can advantageously be used. For example, devices can be grouped into lines (such as Sharp® AR-Series printers), models (such as Sharp® AR-350 printers), and specific devices (such as the Sharp® AR-350 printer in Building A, Room 10). Other classifications and organizations of devices can be advantageously employed as desired.

As discussed above in connection with FIG. 12, the administrator can add notifications 198 in connection with certain device models. When the add notification tab 198 of the model detail page 190 is actuated, a define notification rules page 230 is accessed. A notification table 230 presents the notification rules administered by the content server 30. In the illustrated table 232, each rule has its own identification (ID), and is preferably associated with a particular model. For each notification rule, certain conditions are set out that trigger the notification. More specifically, the action to be taken upon certain conditions is delineated, and comprises the type of notification to be made.

With continued reference to FIG. 12, the illustrated embodiment contemplates notifications such as generating emails and sending message boxes. Other types of notifications include updates to existing files and/or windows, alarms, pages, telephone calls, overhead pages, or the like. Additionally, notifications can be sent to one or several individuals/addresses. For example, upon notification of an error condition, the system administrator may be immediately notified by e-mail, a suitable technician may be notified via a pager, and a manager having charge of the user operating the relevant equipment, or the equipment itself, may also be notified via e-mail. Notifications may also be triggered by positive events. For example, in accordance with one embodiment, when a user has successfully addressed and resolved in error, an email to the user may be automatically generated thanking the user for their successful efforts. Such email preferably is also copied to the user's manager. Multiple notification rules can be established for any one model or condition. Thus, it is anticipated that several notification rules will be established. Accordingly, and in a manner as discussed above, filtering boxes 234 are provided to help sort through such notifications rules.

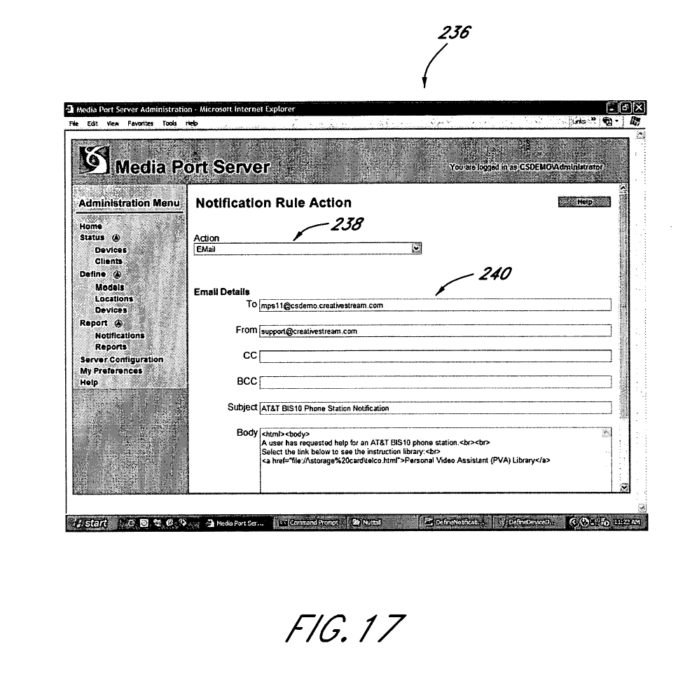

With reference next to FIG. 17, a sample notification rule definition page 236 is illustrated. The notification rule definition page 236 includes an action box 238 defining the action to be taken. In the illustrated embodiment, an e-mail has been chosen; however, as discussed above, several different notification options can be made available. Notification detail boxes 240 are also provided to define certain aspects of the notification. For example, to whom the notification is to be sent, what the subject line should be, body text, etc. It is to be understood that such notifications can include predetermined text alone or in combination with sensed and/or captured data, such as the sensed time, device model, error type, user, and the like. Additionally, the notification can include HTML links to various information, including device history, the instructional library, and the like.

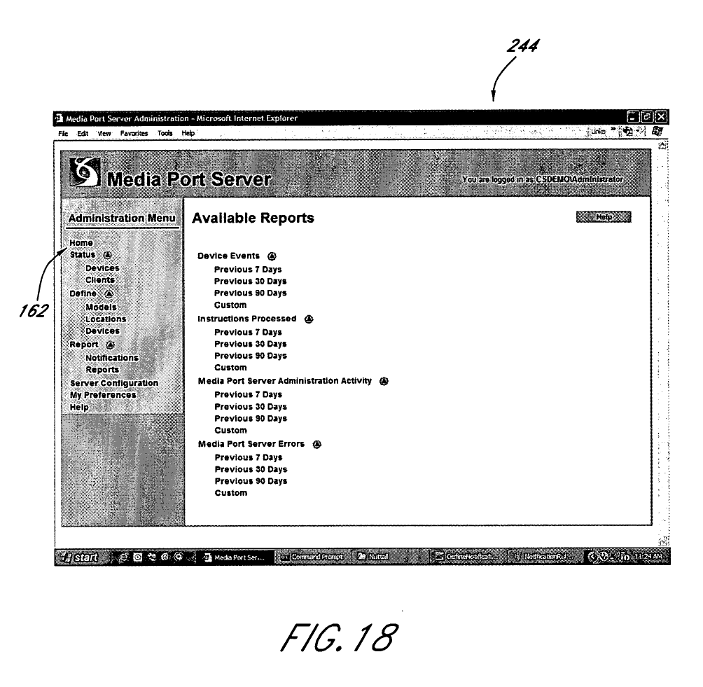

With reference next to FIG. 18, an administrative reports page 244 sets out certain available reports. For convenience, the reports are set out in predetermined formats, such as the previous seven days, thirty days, or ninety days. However, customization of reports is also provided for. Preferably, reports can be generated based upon any type of information recorded in the databases. For example, data tracking performance of particular models, as well as specific devices within a model, can be generated, and even reports comparing the performance of specific devices within a model group or comparing the down-time, number and type of errors, etc., between similar model groups (for example, comparing performance between two different brands of copy machine). Further, reports can be customized to track users or groups of users, and it may be noted that disproportionately high device errors occur with particular users or groups of users, thus indicating a need for training. Similarly, low errors rates may indicate successful training. As is discussed, reports can be customized.

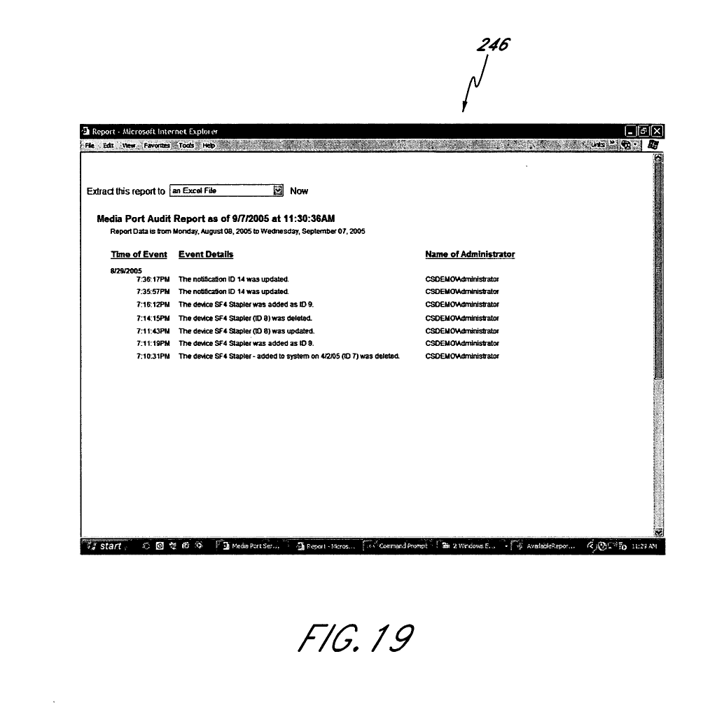

With reference next to FIG. 19, a sample report page 246 is presented, and lists events occurring on the corresponding date. It is to be understood that various filtering rules can be applied to customize reports to particular situations. Some of the report filters by which reports may be sorted and/or generated include equipment line, equipment model, specific device within a model, location of a device, time and date of event, error recorded, user, manager and/or technician responsible for addressing/correcting the event, and down-time of equipment between the initial sensing of an error and correction of the error and restoration of the device to operability. Further, in accordance with the illustrated embodiment, reports can be extracted from the administrative client to more user-friendly and/or sharable formats. For example, as indicated the present report can be extracted to a Microsoft Excel file, which is a spreadsheet format (or CSV-formatted file). Other types of formats, including output to databases, word processing programs such as MS Word, HTML, graphics formats such as Adobe PDF, and the like are anticipated.

Reports can be especially advantageous for making better business decisions. Specifically, decisions whether to continue buying certain lines and models of products can be made based on historical data monitoring the performance of such products relative to other models and/or the products of other manufacturers. Additionally, technical competence of users, technicians and the like can be easily tracked and reported. Still further, tracking of errors and the like may highlight those who need additional training, and may help an organization prioritize training so that the most important needs are met first. As such, a method of making business decisions includes tracking of such data as discussed above, reporting the data, comparing the data with other comparable groups and/or time based data to track whether there is improvement or not, and making business decisions based on the same. Note also that reports can track whether specific devices or models that include customizations resolve or exacerbate certain errors and/or training deficiencies. As such, tracking of error conditions, user help requests, and the like can aid an organization improve its operations by comparing performance data of “stock” devices with performance data on customized or improved devices.

The administrative client screen views depicted in connection with FIGS. 8-19 depict examples taken from an embodiment of the invention. It is to be understood, however, that the invention is not limited by the approaches and specific organization of these sample views. Rather, these pages present principles associated with administering a client/server system in which one or several types devices are monitored remotely, and instructional media is directed as needed to specific devices and/or device clients.

It is also to be understood that, in other embodiments, there may be multiple administrative client access points. Especially in more complex, large organizations and networks, a plurality of individual administrative clients may each have their own limited scope of authority and access. For example, one administrator may have authorization to access the network via a corresponding administrative client, and is authorized only to change model and device aspects for specific models and devices directly under that administrator's control (for example, only copy machines and scanners, or only devices in the Western U.S. states). Such an organization may also include multiple administrative client access authorization levels, so that other administrators may have greater access and/or authority. Further, the administrative client, though depicted schematically as a desktop computer, can be any appropriate computing device, including a laptop, PDA, tablet PC, mainframe station, or the like. Preferably, access to the content server 30 is password protected, and communications therewith are protected by data encryption.

In still further embodiments, access considerations are made to allow users to access and modify their instructional media delivery preferences, as recorded in the user database 124. In accordance with one embodiment, the content server 30 of an organization is linked to another organization server and adapted so that a user that is logged in to the server may be granted authorization and access to modify such preferences. Potentially, such preferences may be quite detailed. For example, a user may define color schemes, text font and size, media window size, whether or not to activate options such as provision of subtitles, preferred languages for audio, subtitles, and written instruction, and such. Preferably, however, the user would have only limited access, and would not be able to modify historical data or the like. Additionally, in one embodiment, a user cannot directly modify their preferences, but rather may submit a request for such modification, which request would be formally instituted by the system administrator.

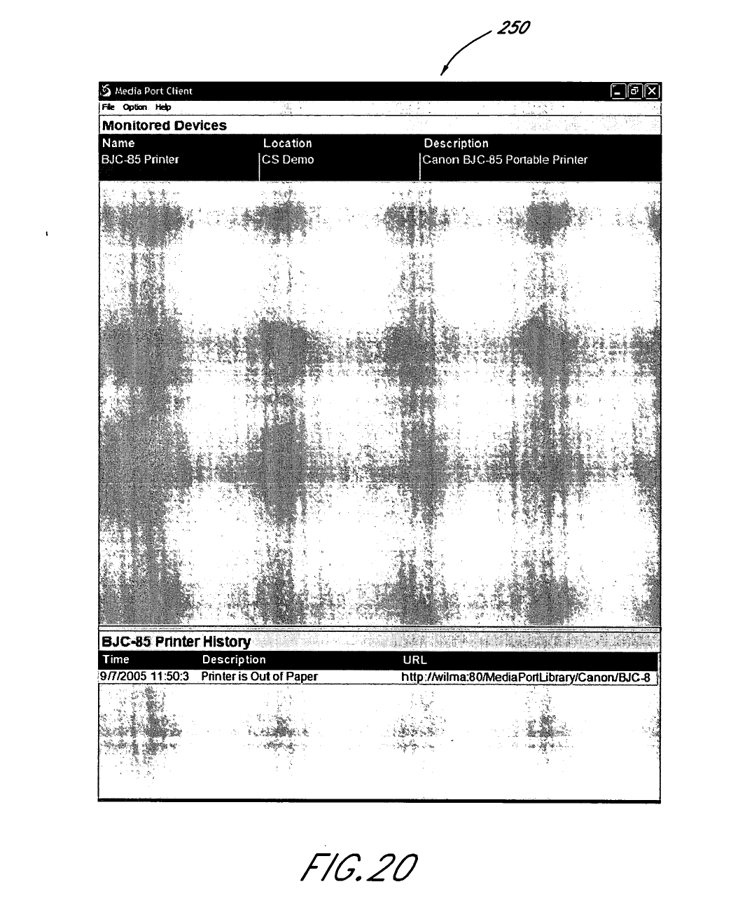

With reference next to FIG. 20, another embodiment of a device client page 250 is presented. As discussed above, the device client 34 generally comprises a graphical display at or adjacent a corresponding monitored device 32. In accordance with certain sensed conditions, the content server 30 directs delivery of instructional media to the device client 34. The illustrated client page 250 does not depict delivered instructional media, which is shown above in connection with FIG. 4. Rather, device client page 250 illustrates a description of the device monitored by the device client 34, as well as a history of the device.

With continued reference to FIG. 20, preferably the history listing includes a URL link to instructional media. As such, if a user is interrupted when attempting to follow instructional media in accordance with FIG. 4 as discussed above, and for some reason the screen is canceled, the user can resume the instruction without necessarily repeating the error or other trigger. More specifically, by clicking or otherwise actuating the HTML link, the instructional media is again accessed and displayed, and the content server 30 becomes appropriately involved in helping the user resolve the matter.

In the embodiment illustrated in FIG. 20, the device client page 250 is in the format for a tablet PC. It is to be understood, of course, that various types of graphical display formats can be provided for various types of device clients 34, such as tablet PCs, desktop computers, PDAs, mainframe stations, and the like.

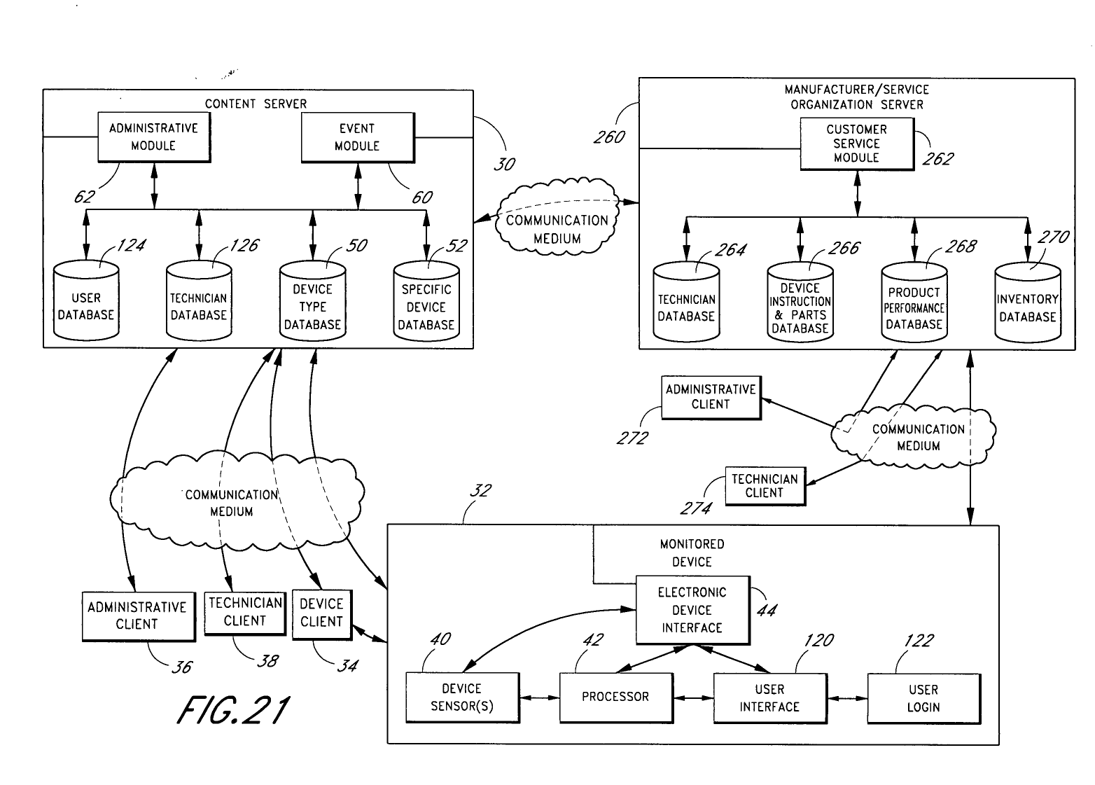

The embodiments discussed above in connection with FIG. 5 were presented in the context of a single company or organization that is monitoring certain of its own devices. As discussed, any one content server 30 may simultaneously monitor devices of several different models, types and manufacturers. With reference next to FIG. 21, another embodiment is illustrated in which the content server 30 and monitored device 32 can further interact with a manufacturer/service organization server 260.

In the embodiment illustrated in FIG. 21, the manufacturer/service organization server 260 is associated with either a particular manufacturer, who deals exclusively with models and devices that it has manufactured, and/or a service organization which may deal with a limited field of device type and/or line. In the illustrated embodiment, the manufacturer/service organization server 260 is adapted to provide additional support to the content server 30 in connection with specific models. As such, a content server 30 may selectively communicate with several different manufacturer servers 26 in order to obtain additional support for a wide range of models and device types, since a particular manufacturer or service organization will only service certain limited device types.

As illustrated, the content server 30 and manufacturer server 260 preferably are adapted to communicate with one another over a network, such as the Internet, or another type of communication medium. Preferably, data is transferred over a secure line, such as by a VPN connection. However, the manufacturer server 260 preferably has access only to database information and the like that is relevant to its particular needs. Such access can be defined by the administrative client 36 of the content server 30. Similarly, the content server 30 will only have access to certain database and other information of the manufacturer server 260 as defined by an administrative client 272 of the manufacturer server 260.

With continued reference to FIG. 21, upon detection of certain device conditions by the content server 30, the content server 30 may selectively contact the appropriate manufacturer server 260 concerning the affected device. Once such contact is made, a customer service module 262 of the manufacturer server 260 determines what additional service may or should be provided, and/or simply records certain event conditions communicated by the content server 30. Preferably the manufacturer server 260 has access to a technician database 264, a device instruction and parts database 266, a product performance database 268, and an inventory database 270. Further, an administrative client 272 preferably provides access, configuration, and interaction with the manufacturer server 260 in order to administer the server 260 and, a technician client 274 preferably provides further access to the server 260.

The manufacturer server 260 technician database 264 preferably includes much of the same types of information as the technician database 126 of the content server 30, but in the context of the manufacturer's organization and needs. Specifically, the technician database 264 stores information concerning the manufacturer's own technician cadre. The device instruction and parts database 266 preferably includes extensive information about certain types/models of devices. It is similar to the device type database 50 of the content server 30 in that it includes the meanings of sensor codes, etc., and can also include instructional media for delivery to a device client 34. Additionally, however, the instruction and parts database 266 includes detailed technical data about the monitored devices, including parts that may be indicated for replacement upon certain sensed conditions. The inventory database 270 preferably enables the manufacturer server 260 to gauge availability of parts, and even generate work orders for such parts. In additional embodiments, rather than an inventory database, per se, the manufacturer server 260 is adapted to interact with an inventory tracking and control system, material requirement processing (MRP) system, enterprise resource planning (ERP) system, or the like in order to determine availability of, and requesting, parts.

The product performance database 268 maintains historical data concerning product performance. For example, it is anticipated that the manufacturer server 260 will communicate with multiple content servers 30 of different organizations, and will be able to track the performance, error occurrences, down-time, parts requirements, user help requests, and the like of the manufacturer's own equipment. Upon receiving such data, the customer service module 262 preferably records it in the product performance database 268. Preparing reports based on such historical data will help the manufacturer track strengths and weaknesses of its products, presumably helping the manufacturer choose how to allocate engineering resources to more effectively develop improvements and resolve certain product issues.

With continued reference to FIG. 21, in accordance with another embodiment, upon the occurrence of certain sensed error conditions in the monitored device 32, the content server 30 may, upon analysis of the sensed error, determine that the error is too complex to be handled by one of its users and/or technicians. Alternatively, the content server 30 may be associated with a small organization that does not have its own technician corps. Further, certain error conditions may require parts and the like that are not necessarily stocked by the organization maintaining the content server 30.

The following embodiment discusses an example in which the content server 30 notes that a replacement part is required to resolve a sensed error condition of the monitored device 32. At such time, the event module 60 contacts the manufacturer server 260 and communicates the error signal and a request for further assistance. The customer service module 262 of the manufacturer server 260 analyzes the error signal and, in light of data in the device instruction and parts database 266, determines which replacement part is indicated. The customer service module 262 then accesses the inventory database 270 (or a bridge to an inventory control system) to determine whether the part is available. The customer service module 262 also accesses the technician database 264 to select and schedule an appropriate technician for installation of the part and resolution of the matter. Preferably, a work order including both a part request and technician request are generated; preferably both the part and technician are reserved, and the part is ordered for pick-up by the selected technician. Preferably, the selected technician carries a mobile technician client 274 with him to the location of the monitored device 32. The technician preferably receives instruction via the technician client 274 in replacing the part and resolving the error with the monitored device 32. In some embodiments, the device client 34 can be used in lieu of a technician client 274.

In accordance with the above-discussed embodiments, it is to be understood that not only can resolution of relatively simple errors be resolved simply by the content server 30 providing appropriate instructional media to a device client 34, but more involved errors, such as those requiring replacement parts and the like, can be detected and service can be scheduled and performed without requiring the affirmative intervention of an administrator. As such, down-time is reduced, incorrect diagnoses are avoided, and the process becomes more efficient and reliable.

With continued reference to FIG. 21, a direct communication link is illustrated between the monitored device 32 and the manufacturer server 260. Such a direct communication link may be advantageous in certain embodiments, and for certain sensor readings, the monitored device 30 can effectively bypass the content server 30 and deal directly with the manufacturer server 260. In connection with still further embodiments, the manufacturer server 260 can, for all intents and purposes, operate in a manner similar to the content server 30. A key difference being that the content server 30 is preferably administered more locally, such as by the organization owning the equipment or a contracted service, and the manufacturer server 260 is administered more remotely by the company that manufactured the monitored equipment. In embodiments such as the embodiment discussed in the immediately preceding paragraphs, the manufacturer server 260 communicates with the monitored device 32 only by way of the content server 30, and has no direct connection.

In additional embodiments, the manufacturer server may also be notified of all sensed error conditions and/or user help requests, thus providing the customer service module 262 with more thorough product performance data to record in the product performance database 268.

In the embodiments discussed above in connection with FIGS. 1-6, example embodiments were discussed using a sensed error condition to illustrate certain inventive principles. It is to be understood; however, that such inventive principles can be applied in other contexts. For example, with reference again to FIG. 6, decision block 76 is predicated upon the detection of an error signal. In another embodiment, a similar logical flow plan would follow if decision block 76 were predicated upon the detection of a maintenance need. Such a maintenance need could be detected both as a determination of sensed conditions and/or upon analysis of data such as the time since previous maintenance was performed, the use level of the device or a portion of the device 32 since the last maintenance was performed, or the like. In any case, upon a determination of a maintenance need, a proposed flow chart would proceed in a similar manner as discussed in connection with FIG. 6, until the maintenance is correctly performed and decision block 84 indicates that maintenance is no longer needed.

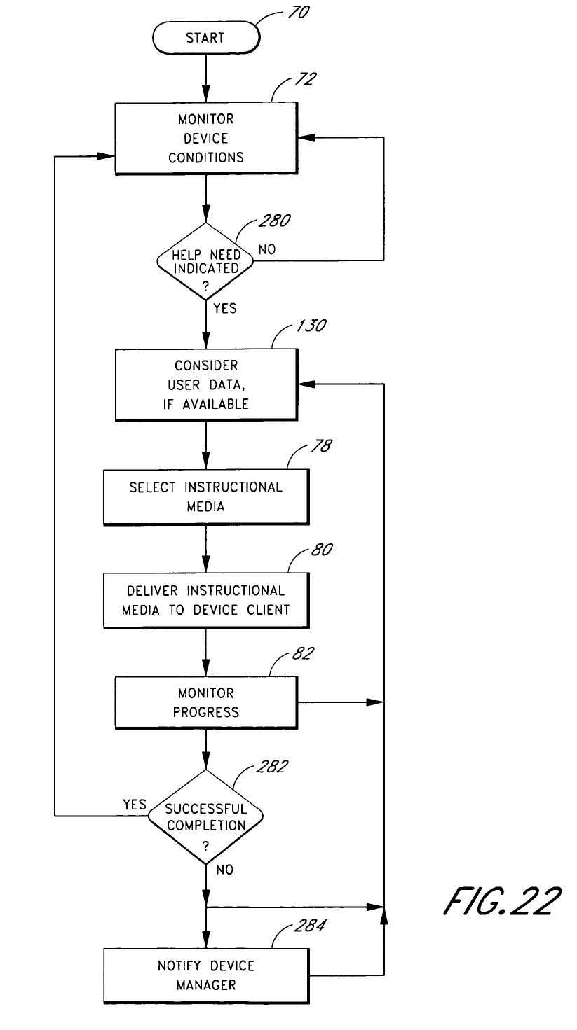

With reference next to FIG. 22, still another embodiment is presented that shares many similarities with the embodiment discussed above in FIG. 6. Such similar discussions are indicated by the same reference numerals as used above in connection with FIG. 6. As shown in FIG. 22, however, decision block 280 involves a detection of whether a help need is indicated. It is to be understood that a help need can be indicated in multiple ways. For example, in accordance with one embodiment, the device 32 and/or device client 34 includes a help button by which the user may request help with certain operations. In more complex equipment, a library of functions or operations of the device may be included, and, via the device client 34, the user may request help or instruction on performing a specific operation of the device. For example, a laboratory test instrument may be capable of performing several different types of tests, and a user may wish to perform one such test, but lacks sufficient familiarity with the machine to be confident in performing the tests correctly. Thus, the user wishes full motion video instruction to help ensure the user uses the device correctly.

With continued reference to FIG. 22, when a help need is indicated, the content server 30 operates substantially as discussed above. In accordance with blocks 130 and 78, the content server 30 selects instructional media that is appropriate to the help need indicated and user's technical skill. Similarly, the content server can monitor the progress of the user in performing the operation in accordance with block 82 in order to ensure that the user is performing the operation correctly. Further, in accordance with decision block 282, the content server 30 preferably tracks the operation as performed by the user to ensure that the user has performed all the appropriate steps to correctly perform the operation. If the user is successful, then the device returns to normal monitoring conditions; however, if the user is unsuccessful in following the instructional media, preferably the manager of the particular device is notified in accordance with block 284 in order to provide the user with more personal assistance and/or to ensure the user does not inappropriately use or damage the equipment.

In accordance with block 280 of FIG. 22, another manner in which a help need may be indicated is when device conditions as monitored by the content server 30 do not match up to device conditions when performing certain operations. For example, if sensed conditions indicate that a user has performed certain steps of certain operations in the wrong order or simply has performed incorrect steps, a help need may be identified in accordance with block 280. At such time, the content server 30 preferably provides correcting instructional media to enable the user to correct the procedure anomalies in a manner similar to the embodiment just discussed. As such, even a generalist user may effectively operate specialized devices which typically require significant training.

In accordance with yet another embodiment, the content server 30 can be used to create training protocols and simulations. For example, the administrative client 36 may be adapted to selectively direct the content server 30 to simulate a particular error in a particular device 34 for training purposes. The content server 30 then proceeds in accordance with the embodiment described in connection with FIG. 6 as though the error signal were real. Additionally, and in connection with a further embodiment, as devices are improved, upgraded parts and/or systems may be provided by a manufacturer. The content server 30 may also be updated with instructions for installing such upgrades. As such, the content server 30 and device 32 client server arrangement can be used as a universal platform helping to provide efficient resolution of maintenance issues, error correction, operational assistance, training, upgrade instructions, and the like.

In the embodiments described above, it has been anticipated that the content server 30 has access to libraries of instructional media, and that pursuant to the content server's instruction, such media is delivered to a device client 36 and/or technician client 38. Presumably, such media is streamed over the network or other communication line. In accordance with another embodiment, the device client 36 and/or technician client 38 includes a stand-alone version of the library of instructional material. The content server 30 is aware of and has remote access to the library of material, which functionally is preferably part of the device type database 50 and/or database 52 for purposes of this specification. Accordingly, when the content server 30 selects appropriate instructional media, it instructs the corresponding client 36, 38 to run the appropriate media rather than affirmatively delivering the media to the client. Thus, although instructions from the content server 30 to the client 36, 38 are communicated over the communication medium, the actual instructional media files are not. This can result in increased speed in delivery of such media, especially if such media involves full motion video or the like.

In accordance with still another embodiment, a content server may monitor devices without necessarily providing a graphical user interface device client, and instead using a mobile technician client 36. For example, in one embodiment, several vending machines are monitored by sensors and/or computer memory in order to track the inventory of each vending machine. In accordance with one embodiment, each vending machine is programmed to communicate inventory and/or other conditions, such as money accepted and change available, by a telephone, wireless, satellite connection, or the like to a content server 30. Based upon the information received, and upon rules delineated in a database, the content server 30 determines inventory/restocking needs for each vending machine, as well as other needs, such as maintenance or service. Similarly, the content server may prioritize the order in which vending machines are restocked. Most preferably, the content server constructs a schedule for a technician to restock and service the vending machines according to the priority order, and further considering geographic proximity. Preferably, the server also develops an inventory of items for the technician to take on his route. In a still further embodiment, the content server automatically orders certain items (such as food items).

The content server preferably communicates route/schedule information to the technician via the technician client 38. The technician then follows the route and schedule created by the content server to refill the vending machines appropriately. As such, via periodic monitoring, vending machines are kept stocked and vending machine routes are more efficiently managed. Further, it is to be understood that other indications may prompt a special monitoring. For example, if a sensor reads that a vending machine has been depleted or is in danger of depletion of a particular product, or if there is an urgent service need, such as an interrupted power supply, the machine may be prompted to automatically signal the content server 30 regardless of any predetermined update schedules.

In accordance with a yet further embodiment, it is contemplated that content server systems may be set up in accordance with principles of redundancy, disaster recovery, and fail-over technology so that failure of a computing device, or group of such devices, will have minimal impact, if any, on operation of the system. For example, in another embodiment, a plurality of content servers operate substantially independently of one another, but are linked so as to replace one another in the event of a failure. In this embodiment, preferably copies of necessary databases (including instructional materials), administrative information, (such as device and model data and IP addresses), and the like, are stored in each of the servers and, upon indication of a server failure, the remaining servers take over monitoring and responding duties previously assigned to the now-offline server.

In the embodiments above, references have been made to separate databases. It is to be understood, however, that such databases are not necessarily maintained separately. In fact, a single master database may include all of the information referred to in the databases referred to above. Conversely, such information may be distributed between several smaller, separately-maintained databases. Further, the term “technician” as used above as a broad term, and does not necessarily imply any specialized technical training.

Although this invention has been disclosed in the context of certain preferred embodiments and examples, it will be understood by those skilled in the art that the present invention extends beyond the specifically disclosed embodiments to other alternative embodiments and/or uses of the invention and obvious modifications and equivalents thereof. In addition, while a number of variations of the invention have been shown and described in detail, other modifications, which are within the scope of this invention, will be readily apparent to those of skill in the art based upon this disclosure. It is also contemplated that various combinations or subcombinations of the specific features and aspects of the embodiments may be made and still fall within the scope of the invention. Accordingly, it should be understood that various features and aspects of the disclosed embodiments can be combined with or substituted for one another in order to form varying modes of the disclosed invention. For example, in one embodiment discussed above, once a content server 30 has scheduled a technician to perform service on a device 32, a message to that effect is displayed on the device client 34. It is thus anticipated that other embodiments will incorporate similar aspects. For example, the embodiment discussed above wherein a manufacturer server 260 schedules a technician to replace a part in a device can similarly prompt a message to that effect to be displayed on the device client. As another example, an embodiment discussed above discussed a vending machine monitoring system in which scheduling of machine restocking was based partially on priority assigned to certain machine conditions. Similarly, in embodiments discussed above in which technicians may be scheduled, a content server may assign priority based on the importance of certain errors and/or devices, and may schedule accordingly. Thus, as shown in these examples, Applicant expressly anticipates that principles discussed herein in connection with certain embodiments should be freely mixed and combined with other embodiments, if applicable. As such, it is intended that the scope of the present invention herein disclosed should not be limited by the particular disclosed embodiments described above, but should be determined only by a fair reading of the claims that follow.

What is claimed is:

1. A system for monitoring a device and delivering context-appropriate instructional information to a user interface, comprising:
a device having at least one sensor adapted to detect a condition of the device and to generate a sensor signal indicating the detected condition;
a content server adapted to receive and analyze the sensor signal, the content server comprising a device database having technical information concerning sensor signals, comprising a library of instructional material corresponding to particular sensor signals, and a criteria for determining whether a sensor signal indicates a potential need for instructional material;
wherein the content server is adapted to access the device database to determine the meaning of the sensor signal, whether instructional material is indicated, and to identify appropriate instructional material based upon the sensor signal if indicated; and
a user interface;
wherein the content server is configured to communicate the identified instructional material to the user interface.

2. The system of claim 1, wherein the user interface is positioned at or adjacent the device.

3. The system of claim 2 additionally comprising a user login, and the content server identifies a logged in user.

4. The system of claim 2 additionally comprising a user database comprising at least one user profile.

5. The system of claim 4, wherein the content server is adapted to identify an appropriate instructional material based at least in part upon the user profile.

6. The system of claim 1, wherein the instructional material comprises multi-media material.

7. The system of claim 6, wherein the instructional material comprises full motion video.

8. The system of claim 1, wherein the sensed signal indicates an error condition, and the corresponding instructional material comprises instructions how to resolve the error condition.

9. The system of claim 1, wherein the sensed signal indicates a request for instructions concerning performing an operation, and wherein the corresponding instructional material comprises instructions how to perform the operation.

10. A method for remotely monitoring a plurality of devices and delivering context-appropriate media, comprising:
electronically receiving a first error signal corresponding to an error condition detected in connection with a first one of the monitored devices;
providing a database comprising a plurality of instructional media files comprising instructions for resolving a plurality of potential error conditions of the monitored devices, the database correlating a first instructional media file to the first error condition signal;
accessing the database and identifying the first instructional media file as corresponding to the first error condition signal; and
delivering the first instructional media file to a user interface.

11. A method as in claim 10, wherein the user interface is at or adjacent the first monitored device.

12. A method as in claim 11, wherein the user interface comprises a graphical user interface.

13. A method as in claim 10 additionally comprising accessing a technician database and selecting a technician qualified to resolve the error condition.

14. A method as in claim 13 additionally comprising automatically scheduling the selected technician.

15. A method as in claim 14 additionally comprising generating an electronic notification of the error condition and schedule to the technician.

16. A method for remotely monitoring a device and delivering context-sensitive instruction, comprising:
receiving an electronic signal indicating a device condition;
accessing a database to determine whether a response action is warranted in response to the device condition;
if a response action is warranted, accessing a database to provide instructional media concerning the device condition; and
directing delivery of the instructional media to a user interface.

17. A method as in claim 16, wherein a response action is warranted if the device condition indicates a device error condition.

18. A method as in claim 16, wherein a response action is warranted if the device condition indicates a device maintenance need.

19. A method as in claim 16, wherein a response action is warranted if the device condition indicates a user help request.

20. A method as in claim 16, comprising monitoring whether a device procedure is being performed properly by monitoring sensed device conditions and comparing sensed device conditions to expected device conditions corresponding to the device procedure, and a response action is warranted if sensed device conditions do not correspond to expected device conditions.

21. A method as in claim 16, wherein the instructional media comprises full motion video.

22. A method as in claim 21, wherein the user interface is disposed at or adjacent the device.

23. A method as in claim 16 additionally comprising accessing a database including user preferences, and selecting aspects of instructional media based partially on user preferences.

24. A method as in claim 23, comprising formatting delivery of instructional media based at least partially on predefined user preferences.

25. A method as in claim 24 additionally comprising determining audio or written text language delivery based at least partially on predefined user preferences.

26. A method as in claim 16, additionally comprising accessing a database to determine a preferred language for delivering instructional media to the device.

27. A method as in claim 16 additionally comprising generating an electronic notification to an additional client upon determination of a response action.
